(19) United States
(12) Patent Application Publication
(10) Pub. No.: US 2025/0362126 A1
(43) Pub. Date: Nov. 27, 2025

(54) INDEXED ARTICULATED JOINT

(71) Applicant: HEXAGON MANUFACTURING INTELLIGENCE SÀRL, Renens (CH)

(72) Inventors: Claude ROUGE, Baulmes (CH); Abhijeet SINGH, St. Sulpice (CH); Léonard WUNDERLIN, Tolochenaz (CH)

(73) Assignee: HEXAGON MANUFACTURING INTELLIGENCE SÀRL, Renens (CH)

(21) Appl. No.: 19/215,783

(22) Filed: May 22, 2025

(30) Foreign Application Priority Data
May 23, 2024 (EP) 24177754.9

(51) Int. Cl. G01B 21/04; B25J 17/02

(52) U.S. Cl. CPC G01B 21/047; B25J 17/0283

(57) ABSTRACT

An indexed articulated wrist for the reorientation of a metrological tool mounted on a positioning platform, comprising a modified Hirth coupling wherein several teeth have been omitted to simplify the construction and reduce its cost. The modified Hirth coupling has, one toothed crown with a reduced number of teeth spaced apart by a multiple of the indexing pitch and a second crown with a plurality of toothed sectors, each with a plurality of teeth spaced apart by the pitch angle, the toothed sectors being separated by non-meshing sectors.

### REFERENCE DATA

The present application claims priority of European patent application EP 24177754.9 of 23 May 2024, the contents whereof are hereby incorporated entirely by reference.

### TECHNICAL DOMAIN

The present invention concerns an indexed articulated joint for a measuring apparatus, such as a coordinate positioning apparatus or a coordinate measuring machine. The indexed articulated joint of the invention is especially adapted for use in a wrist or a probe holder mounted on a positioning platform of the apparatus and supporting a metrological tool in a reorientable fashion so as the metrological tool can be positioned and oriented relative to a piece that is measured. The indexed articulated joint of the invention is also adapted for use in an indexable rotary table supporting the piece to be measured. However, the invention may be applied to other domains, such as machine tools and robotics.

### RELATED ART

Coordinate measuring machines (CMM) are a kind of coordinate positioning apparatus that uses a variety of probes attached to a moveable position platform to provide coordinates of points on the surface of a piece that is measured. In known bridge-type coordinate machines, the positioning platform is part of a precise cartesian positioning system and its position, relative to the reference table of the machine, is read by accurate linear encoders. Wrist-type coordinate machines and industrial robots—which are sometimes equipped with coordinate probes for measurement purposes—have a kinematic chain of rotation axes, in series, and determine the coordinates of the positioning platform are deduced from the rotation angles, read by angle encoders. A rotational axis can be, alternatively or complementarily, provided by a probe holder having a rotating adapter for a measuring probe, or by a rotary table supporting the workpiece to be measured.

Touch coordinate probes are used with coordinate measuring machines for checking dimensions or surfaces of machined parts and to capture the three-dimensional shape of pieces, for example to reproduce or model them. Touch coordinate probes have, in general, a mobile feeler designed to be brought into contact with the surface of the piece under test. A sensor reacts to the slightest displacement of the feeler and provides an electric signal that is sent to an operator or to an automatic controller. The sensor can be a trigger circuit, producing an electrical transition whenever a contact happens, or a deflection transducer that yields a measure of the deflection in one, two, or three coordinates. Touch probes with deflection sensor also come under the name of scanning probes or analogue probes and can be used by sliding their feeler along the surface of the piece, whereas those of the former kind, more common, are also called trigger probe and are often used by tapping the surface in discrete points and gather information on a discrete set of points on the surface of the piece under test.

Contactless coordinate probes are also known in the art. They use a contactless sensor to determine the distance between, for instance, a tip of the probe and the surface of the object under test without touching it. This class of probes includes laser interferometric probes, chromatic confocal probes, ultrasound probes, cameras, line scanners and many other.

Coordinate machines can equip other tools different from coordinate probes, for example surface quality probes that measure roughness, or imaging devices for inspection and control. For this disclosure, these tools are equivalent to coordinate probes and interchangeable therewith.

Coordinate probes can be used in the art also in mobile parts of machine tools, for example milling machines, lathes, and machining centres.

Many measurements require changing the orientation of a coordinate probe to measure a workpiece completely and satisfactorily. When measuring features at the blind end of a hole, for example, being able to align the axis of the probe with that of the hole is very useful. Many movable platforms do not offer this capability and coordinate probes are often mounted on an articulated wrist to overcome this lack. Typically, articulated wrists used in these applications have two independent orthogonal axes in series, but realizations with fewer or more degrees of freedom are possible.

Rotation axes of reorientable wrists are often indexed, meaning that they can be locked in a large but finite number of predetermined positions that are accurately repeatable. This requires in general a locking mechanism having indexing elements or components such as a periodic joint, such a Hirth coupling with a periodic arrangement of radial grooves on a ring that form a crown of intermeshing teeth. In the locked state—also denoted as locked configuration in this disclosure—indexed axes are blocked by pushing the two halves of the joint one against the other, while in the free state (or free configuration) they are set apart and are free to rotate one relative to the other. the rotation and the transition between the locked state and the free one can be manual or automatic. Indexation pitches of 1°, 2.5°, 5°, 7.5°, 10° or 15° are known.

Hirth couplings provide precise indexation and fine pitch angles in a small space, but their production requires high-precision grinding and is costly.

Documents EP 1666832 B1, EP 1666833 A1, EP 0392660 A1, EP 1672309 B1, EP2889573 B1, EP 3184960 B1, EP 3179203 B1, U.S. Pat. No. 10,557,702 B2, WO 2024/033613 A1, EP 3129750 B1, US 2015/176958 A1 describe articulated devices for coordinate measurement probes. GB 1411331 A discloses an indexing mechanism involving an arrangement of superposed toothed discs

Some measurements can take benefit from changing a single orientation of the coordinate probe and/or of the workpiece around an axis. In such case, the coordinate probe can be mount of a probe holder having a rotating adapter for supporting the probe. Alternatively, or complementarily, the apparatus can comprise a rotary table for orienting the workpiece around an axis. Rotation axes of reorientable probe holder and rotary table can be indexed, meaning that they can be locked in a large but finite number of predetermined, accurately repeatable positions.

### SHORT DISCLOSURE OF THE INVENTION

An aim of the present invention is the provision of an indexed articulated joint for an articulated wrist that can provide fine pitch indexation at a lower cost.

According to the invention, these aims are attained by the object of the attached claims, and especially by an indexed articulated joint for an articulated wrist for the reorientation of a metrological tool mounted on a positioning platform, the articulated wrist comprising: a support element capable of being mounted on the positioning platform, a reorientable element rotatably connected to the support element such that the reorientable element can be rotated relative to the support element about a first rotation axis between and locked at one of a plurality of indexable orientations separated equally by a pitch angle, wherein the support element and the reorientable element include a modified Hirth coupling with a pair of mutually intermeshing components that can be unlocked by separating them along the first rotation axis to enable a change from one indexable orientation to another indexable orientation and locked together by urging them one against the other to provide any one of the indexable orientations, characterised in that a first component of the mutually intermeshing components is a toothed ring with a plurality of teeth spaced apart equally by a multiple of the pitch angle (i.e. an integer number more than one), a second component of the mutually intermeshing components has three or more toothed sectors separated by non-meshing sectors, each toothed sector comprising a plurality of radial teeth spaced apart by the pitch angle configured such that, when the first component and the second component are locked together in any of the indexed positions, each one of the toothed sectors intermeshes with at least one tooth of the first component and there is a clearance between the non-toothed sectors and the first component.

Embodiments of the invention may present the same number of equally spaced teeth in each sector. These highly symmetrical configurations provide a joint having a plurality of indexable orientation with a (substantially) uniform joint rigidity and load charge capacity.

The invention also encompasses embodiments where the teeth are not present in equal number in the different sectors, and/or the non-meshing sectors may have different angular dimensions (i.e. different multiples of the pitch angle) such that the sectors are unequally spaced. These embodiments may exhibit enlarged and/or reduced contacting zone(s) between the pair of mutually intermeshing components, notably for locally modifying the joint rigidity and/or load charge capacity.

The use of a Hirth coupling structure enables finer pitch indexation than what can be obtained with other known periodic couplings, for example of the pins-sphere kind, while the modified Hirth coupling further allows a costs reduction by limiting the number of expensive operations required to machine the modified Hirth coupling with respect to a conventional Hirth coupling.

The integer ratio between the angular spacing of adjacent teeth in the first component and the pitch angle may be denoted by K. For the symmetry, K will be an exact divider of the total number of teeth, K being greater than 1. The inventors determined that K teeth in each toothed sector are necessary and sufficient to ensure that, for all indexed positions, each toothed sectors intermeshes with at least one tooth of the first component. In this case and in some indexed positions, however, the intermeshing involves two distinct teeth on the first component, each touching the second component with one flank while, in other indexed positions, each toothed sector intermeshes with both flanks of exactly one tooth of the first component. The former configuration is slightly less desirable, however, because the forces of contact on each tooth of the first component do not balance in the horizontal plane, and a deflection may ensue.

To avoid this, it may be advantageous to increase the number of teeth in each toothed sector to K+1 or even K+2. In this case, there is always one tooth of the first component that touches a toothed sector with both flanks.

The disposition of the invention provides reliable positioning because, at each indexed position, the two components intermesh at several positions equally spaced apart on the circumference, one per each toothed sector. Yet, the number of teeth is considerably lower than in a complete Hirth coupling. To provide some numerical examples, a complete Hirth joint with a pitch of 2.5° would require grinding 144 teeth in each of the two components. incomplete toothing of the invention can provide a considerable reduction in the number of teeth, and a corresponding saving in the manufacturing cost. Three toothed sectors equally spaced apart (at 120°, i.e. joint providing a tripod-shaped coupling) are sufficient, in theory, for a precise positioning, but more may be preferable. Configurations with four (i.e. tetrapod-shaped coupling), five (i.e. pentapod-shaped coupling), six (i.e. hexapod-shaped coupling) or more toothed sectors may be advantageous although, above six toothed sectors, the reduction in the number of teeth that is sought is less pronounced.

Per each given angular pitch and number of toothed sectors, there will be one value (or two adjacent values of K) that minimise the total number of teeth, and the cost of production. In embodiments, the second component may have exactly four, five or six toothed sectors and the ratio K may be exactly four, six or eight. The pitch angle could be 5°, 2.5°, 2°, 1°, or other.

The toothed sectors are configured to provide the desired number of indexed positions. In each of these, each toothed sector intermeshes with at least one of the teeth of the other component of the modified Hirth coupling. This can be achieved, for example, by spacing apart the toothed sectors equally around the circumference and having at least K teeth spaced apart by the pitch angle in each sector. This is not the only possibility, however. A coupling with a pitch angle θ=2.5° and five toothed sectors, for example, would have the sectors slightly shifted from the symmetric positions, because 72° is not an exact multiple of the pitch angle. Asymmetric variants may need more than K teeth per sector to ensure a correct intermeshing in all the indexing positions.

The profile of the teeth in the two components is not constrained by the invention, provided they intermesh reliably. A triangular profile is possible, the angle at the apex line where the two oblique flanks of each tooth meet may be smaller than 90°, for example 60°. According to the invention, teeth are any (radial) protuberances designed for enabling up to facilitate intermeshing movement between the first and second component of the modified Hirth (e.g. tapered protuberances, i.e. protuberances having a narrow distal extremity), the protuberances having flanks designed to provide at least a partial contact (e.g. a point-, line-, spot-shaped contact) with flanks of intermeshed opposite teeth. Teeth of different components can have different shapes if they enable intermeshing with at least partial contacts between flanks of opposite teeth. Teeth can be manufactured by machining (notably milling or grinding) metallic (e.g. stainless steel) cylindrical pieces, other material and manufacturing process are possible (e.g. additive manufacturing, injection moulding), notably for reducing costs, however. Additional process can be used, e.g. for reducing wear and/or facilitating intermeshing, such as teeth coating and/or lubrication.

The rotation of the wrist and/or its locking and unlocking may be provided by automatic actuators, for example electric motors, or by a manual mechanism. In both cases, more advantageously in the former, the wrist may comprise an angle encoder to measure the relative rotation from which the orientation of the probe can be deduced. Moreover, the joint can alternatively or complementarily comprise a sensor sensing a relative 6dof position (i.e. a relative position along 3 orthogonal linear axes and around 3 orthogonal rotational axes) of the two mutually intermeshing components of the modified Hirt. This 6dof sensor can thus be used not only as angle encoder but also as sensor supporting collision detection and/or measurement error corrections. In one embodiment, the reader of the 6dof sensor can be fixed on one of the two mutually intermeshing components, while the related scale can be fixed on the other of the two mutually intermeshing components. A second orthogonal indexed axis of rotation may be included, in series with the first one, to increase the possible orientations of the probe in space. To this end, the articulated wrist may have an additional reorientable element rotatably connected to the first one such that an orientation of the additional element relative to the reorientable element can be changed between, and locked at one of, a plurality of indexable orientations about the second axis. The tool in this case will be affixed to the additional reorientable element.

The indexed articulated joint of the invention can also be used in a probe holder having a rotary adapter in form of an indexable reorienting adapter, the probe holder being mounted on the positioning platform of the measuring apparatus, eventually supported by an articulated wrist. The indexed articulated joint of the invention can also be used, alternatively or complementarily, in in a rotary table providing an indexable reorientation of the supported workpiece within the measuring volume of the measuring apparatus. The rotary table being configured to be mounted on a reference table of the measuring apparatus and/or to a surface thereof.

A preferred use of the invention is in an articulated wrist for a coordinate measuring machine to reorient a coordinate probe, such as a touch probe, or a contactless coordinate probe, or a camera, and/or to reorient a workpiece to be measured, and this use case will be given special space in the following detailed description. Other applications are possible, however.

### SHORT DESCRIPTION OF THE DRAWINGS

Exemplar embodiments of the invention are disclosed in the description and illustrated by the drawings in which:

FIG. 1 shows schematically a coordinate measuring machine with the automatic reorientable wrist of the invention measuring a workpiece under the supervision of a digital controller,

FIG. 2 shows schematically a reorientable wrist as used in the present invention,

FIG. 3 shows a variant of a modified Hirth coupling used in the invention,

FIGS. 4a-4d shows, in an idealized fashion, the relative position of the intermeshing components, in four indexable positions,

FIG. 5a is like FIG. 4d and represents a variant of the invention with a different disposition of teeth in one of the intermeshing components, and

FIG. 5b is an enlarged view of detail “C” in FIG. 5a.

In the figures, remarkable elements are identified by reference signs that are repeated in the text. The same reference sign may be used to identify distinct elements that are identical, similar, or technically equivalent. When many identical, similar, or equivalent elements are present in a figure, some reference signs may have been omitted to avoid overcrowding the drawing.

### EXAMPLES OF EMBODIMENTS OF THE PRESENT INVENTION

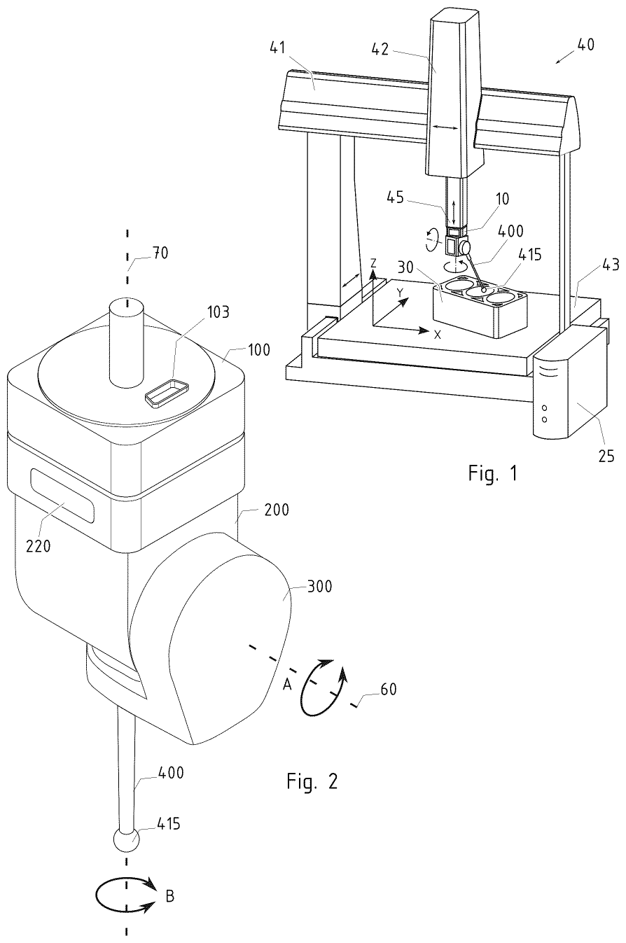

FIG. 1 shows a coordinate-measuring system including a coordinate measuring machine 40 of a known type. The coordinate measuring machine 40 has a horizontal table 43 on which the workpiece 30 that is measured rests. The bridge 41 moves along one first linear axis (Y) on the table 43, and the carriage 42 moves along a second linear axis (X) orthogonal to the first one. The vertical spindle 45 (also called quill or Z-ram, according to different conventions) moves on a third orthogonal axis (Z), such that the end extremity of the spindle 45 is a positioning platform that can be positioned at any desired point in the measuring volume of the machine (i.e., in the volume where the CMM is able to provide a measure of a surface of an object). Suitable encoders (not represented) read the positions of the bridge 41, carriage 42 and spindle 45 along the measuring axes X, Y, Z. Most CMM machines are automatic and the motion of bridge 41, carriage 42 and spindle 45 is determined by electric motors, but manual machines exist. A machine controller 25 is programmed to command the motors according to a predefined measuring plan that is designed in consideration of the shape of the workpiece 30.

FIG. 1 also shows a touch probe 400 that has a spherical tip 415 designed to touch the workpiece 30 at the desired points. The touch probe 400 is often a trigger probe, configured to generate an electric signal on contact. This signal is used by the controller 25 to store the instantaneous values of X, Y and Z, and compute the corresponding coordinates of the contact point, by known methods.

The trigger probe 400 could be replaced by another kind of coordinate probe, for example an optical non contacting probe, a scanning probe, a “hard” probe and so on, without leaving the scope of the invention. The shape and length of the stylus is not limited, either.

The bridge structure of FIG. 1, while common, is not the only possible. The invention is not limited to this execution but includes all the variety of shapes and structures found in coordinate measuring systems. The invention explicitly comprises systems in which the carriage slides along a horizontal beam that is cantilevered, rather supported at both ends, articulated arm machines exclusively based on rotational degrees of freedom instead of linear ones such as articulated-arm coordinate machines and robots, parallel robots such as delta robots and Stewart platforms, and so on.

The size of the machine can also vary, from benchtop machines to large devices used to measure vehicles, aircrafts, or turbines, without departing from the scope of the invention. The articulated wrist can be mounted vertically or horizontally on the positioning platform of the system. The invention explicitly comprises systems comprising moveable tables, e. g., rotary table, for movably supporting the workpiece during operations (e. g. measurements).

Precision and accuracy in CMM range from sub-micron accuracy in laboratory equipment to maybe 5-100 μm in some industrial application. The invention is applicable to all the variants disclosed herein and, in general, to any kind of mobile platform that can be moved with suitable repeatability and precision.

The use of the reorientable wrist of this invention is not limited to its installation on a coordinate-measuring machine, although this is a preferred and important use case. The wrist could be used on machine tools, industrial robots, machine vision systems, or whenever there is a need to accurately reorient an instrument.

FIG. 2 shows the general structure of an articulated wrist as used in the present invention in combination with a generic coordinate measuring machine. The wrist includes a support element 100 that is configured to be affixed on a positioning platform of a coordinate measuring machine. In many implementations, which include the cartesian coordinate machines, the support element 100 will be translated by the coordinate machine along a desired trajectory without rotation, and the articulated wrist is used to reorient the measure probe according to the needs, for example to insert the probe in a bore, or between the aerodynamic vanes of a turbine. In other cases, the motion of the positioning platform to which the wrist is affixed may include rotations, and in these cases the wrist may be used to compensate for them. The connection between the wrist and the positioning platform can be obtained in any suitable way.

The wrist has a connector 103 to power and control the internal actuators that are responsible for reorienting the probe, and for powering and reading the coordinate probe itself. In the simple case in which the coordinate probe is a touch trigger probe, the only connection that is needed is a current loop that is opened as soon the probe touches the workpiece (i.e. trigger event), but more sophisticated powering and signalling schemas can be used. the connector 103 may include also optical fibre connections, for example in combination with an optical probe, measuring the distance to a workpiece by interferometry, triangulation, time of flight, chromaticity, focus variation, or in any other suitable manner. This does not imply that the connector 103 is essential, though. The inventive wrist could possibly dispose of the connector 103 entirely using a battery and some form of wireless data transmission, for example. The connector 103 may include optical channels, or else the wrist may have an additional connector for optical signals. In alternative, an optical probe equipped on the wrist may be connected to a dedicated measuring apparatus by an optical fibre bypassing the wrist.

The support element 100 is pivotably connected with a reorientable element that can turn relative to the support element about axis “B”. The axis “B” is drawn vertically in the figure, and this is its conventional orientation; therefore, it may be also called a “vertical rotation axis”, although the wrist can be used in any orientation in space.

Importantly, the rotation axis “B” is of the indexed variety, meaning that, besides a “free” status, in which the reorientable element can turn about axis “B”, the wrist has also a locked status, in which the relative position of the first rotor 200 relative to the support element is determined by an internal periodic joint. In the locked status, the rotor is immobile in one of a predetermined plurality of precise and repeatable angles relative to the support 100. The angle of rotation about the axis “B” is preferably adjustable by internal actuators in the wrist and is controlled by digital signals, but the invention covers also manually actuated wrists that are unlocked, reoriented, and locked again in another indexed position by hand.

Preferably, the wrist comprises also an additional reorientable element 300 that is pivotably attached to the first one. The additional reorientable element 300 is capable of being turned about a second axis “A” that is preferably orthogonal to the first axis “B” and is therefore conventionally horizontal. As in the case of the other axis, the rotation of the additional reorientable element 300 is preferably indexed.

The coordinate probe 400 is attached to the additional reorientable element, when present. The drawing shows a touch probe that yields a contact signal whenever the sphere 415 touches the workpiece, or a deflection signal when the sphere, sliding on the surface of the workpiece, is moved away from its rest position. The wrist could be equipped with any kind of coordinate probe, either contact-based or contactless, or with other probes, such as a surface quality probe or a camera.

Through the serial composition of the rotation angles about the axis “B” and “A”, the probe 400 can be aligned with any desired direction in space, with the precision and granularity provided by the indexation. Preferably, the rotation about the axis “B” spans more than one revolution, and even more preferably it is unbound. The rotation of the additional reorientable element about the axis “A” may have a forbidden sector upwards, which matters little when the wrist is attached below a positioning platform, as it is usual.

Optionally, the reorientable wrist may have one (or more) visual indicator(s) 220, that can be activated by a controller of the coordinate machine or autonomously, by a wrist controller circuit. This may be used to signal a contact of the touch probe 415, for example. Complementarily or alternatively, the visual indicator 220 can be activated by a controller of the wrist, for example an operational configuration of the wrist (e.g.) and/or an operational status or configuration of the wrist and/or a sensed environmental factor (e. g. a locked or a free configuration of the wrist, below/upper than a given humidity or temperature level, operational abnormality of an active component of the wrist such as an actuator.

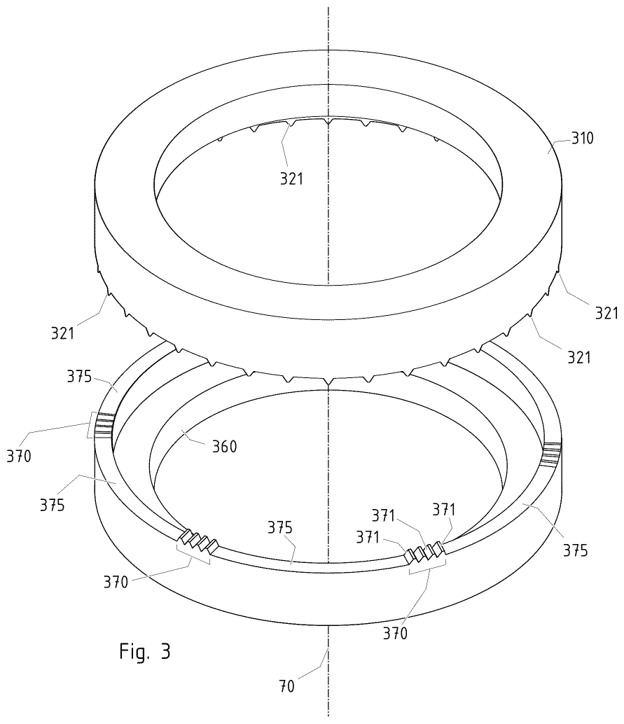

FIG. 3 shows a modified Hirth coupling used to provide the indexation in the invention, the support element 100 and the reorientable element 200 include one each of a pair of mutually intermeshing components 310, 320.

The intermeshing components 310, 320 are disposed coaxially relative to the rotation axis 70 and be unlocked by separating them along the rotation axis 70 to enable a change from one indexable orientation to another indexable orientation and locked together by urging them axially one against the other to provide any one of the indexable orientations.

The first intermeshing component 310 is a toothed crown with a plurality of teeth 321 spaced apart equally by an integer multiple of the pitch angle, oriented towards the second intermeshing component 360. The ratio between the pitch angle and the spacing of the teeth 321, which is an integer value, as mentioned above, may be denoted in the following by K.

The second intermeshing component 360 has various toothed sectors 370 separated by non-meshing sectors 375. In the example, the second intermeshing component 360 has four toothed sectors and an equal number of non-meshing sectors, disposed in a fourfold symmetric pattern. The number of toothed sectors in the invention is not prescribed. Three toothed sectors are enough for providing the coupling's stability when the intermeshing components are locked together (i.e. tripod-based coupling), more toothed sectors are preferred for increasing stability (notably tetra-, penta- or hexapod-based coupling), however.

The modified Hirth coupling of this embodiment provides 144 indexed positions spaced apart by a pitch angle θ=2.5° with a reduced number of teeth. Finer and coarser indexation pitches are also possible, however. The first (upper) component 310 is a crown with teeth 321 equally spaced apart by an angle equal to K×θ, where K is an integer greater than 1. In this case K=4, such that the angle is equal to 10°. Along the circumference and looking down, towards the complementary intermeshing component. The second (lower) component 360 is also shaped as circular crown with six toothed sectors 370 around the circumference. Each toothed sector has K=4 teeth 371 spaced apart by the pitch angle θ=2.5°.

In each of the indexing positions, each of the toothed sectors 370 is in contact with one or two of the upper teeth 321 and the relative position of the intermeshing component is accurately determined. Yet, the combination of FIG. 3 has a total of sixty teeth on both components, to be compared to the 288 teeth that a Hirth coupling with a pitch of 2.5° would normally require.

In other non-represented variants, the number of teeth in each toothed sector 370 may be different than four, for example two, three, five, six, or more. The spacing of the teeth in the first component should be no more than the width of the toothed sectors, to ensure intermeshing in all the indexed positions. Therefore, combinations with a small number of teeth in each of the sectors 370 may be less desirable, because they necessarily have more teeth in the opposite component.

The inventors have determined favourable combinations that provide a precise intermeshing in all the indexed positions with a reduced number of teeth. They include, for an indexation pitch 0=2.5°:

TABLE 1

| | Teeth per sectors | Upper spacing | Teeth total |
|---|---|---|---|
| Sectors | (=K) | (K × θ) | (θ = 2.5°) |
| 3 | 6 | 6 × θ | 42 |
| 3 | 8 | 8 × θ | 42 |
| 4 | 6 | 6 × θ | 48 |
| 6 | 4 | 4 × θ | 60 |
| 6 | 6 | 6 × θ | 60 |
| 8 | 4 | 4 × θ | 68 |

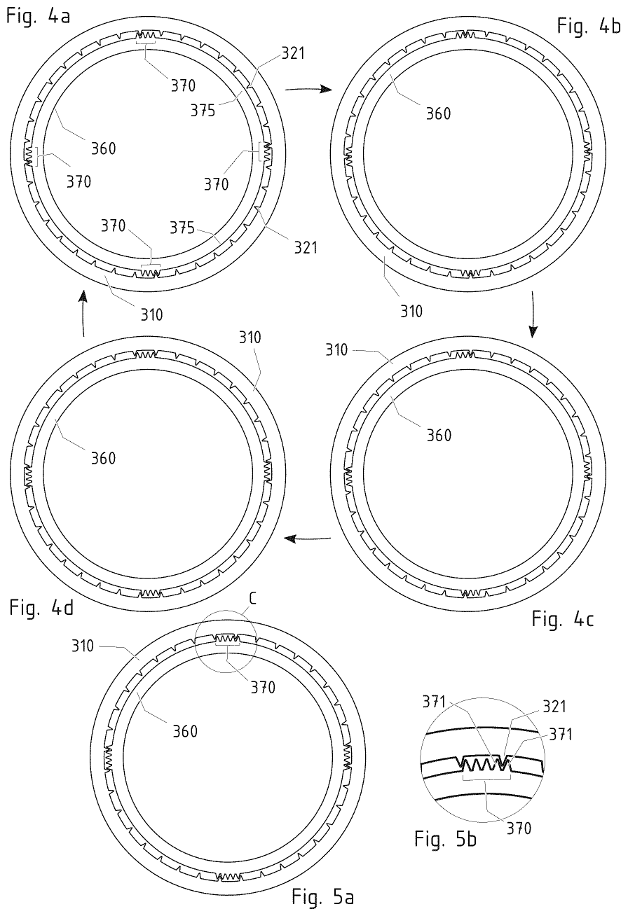

FIGS. 4a-4d show the intermeshing of the modified Hirth coupling of the invention in an example with four sectors of four teeth each, wherein the ratio K is equal to 4. These figures are a conceptual illustration of the device rather than a realistic one: the two components have been flattened to allow a bidimensional representation, and the teeth extend radially rather than axially. Their purpose is to show how a reduced number of teeth can give rise to the full set of indexed position as in a complete Hirth coupling.

FIG. 4a shows the modified Hirth coupling in one indexed position. The first component 310 has four teeth intermeshing with the first and second teeth of each of the sectors 370 of the second component 360. The other teeth of the first component are in face of the non-meshing sectors 375 and do not contribute to the indexation. Since the contact points between the two components are distributed symmetrically around the circumference of the crowns, the positioning is stable and reliable.

FIG. 4b shows the next indexing position, rotated clockwise by θ=2.5 relative to that of FIG. 4a. Four teeth of the first component 310 intermesh with the second and third teeth of the sectors 370. A further step of θ=2.5 produces the configuration of FIG. 4c, and another step of θ=2.5 the configuration of FIG. 4d. As the number of teeth of each sector corresponds exactly to ratio K, in such illustrated configuration of FIG. 4d, the left flank of the first tooth and the right flank of the last tooth in each of the sectors 370 touch a corresponding flank of two successive teeth in the first component 301. In this case the positioning is also symmetrical and reliable.

After a further rotation by θ=2.5 the first component 310 has turned by an angle equal to the separation between its teeth, and the configuration of FIG. 4a is repeated.

FIGS. 5a and 5b show a variant of the invention in which the toothed sectors have one (or two, or more) extra teeth (i.e. >K). In this case, the integer ratio K=4, the spacing between the teeth of the first component is K×θ=10°, and the toothed sectors have each K+1=5 teeth 371. The consequence of this increase is that in all indexed position there is one of the teeth 321 of the first component that is inserted between two teeth 371 of the second component. The contact forces on this contact tooth are symmetrical—which was not the case in the configuration of FIG. 4d—and the indexation is more precise.

In the illustrated embodiments of FIG. 4a-d and FIGS. 5a and 5b, the second intermeshing component 360 comprises four toothed sectors 370 regularly separated by non-meshing sectors 375 of a same length (i.e. a length corresponding to a same multiple of the pitch angle), each toothed sector 370 comprising a same number of teeth 371. These joint embodiments provide a plurality of indexable orientation with a (substantially) constant joint rigidity and load charge capacity.

Alternatively, one or more toothed sectors 370 may have a different number of radial teeth and/or one or more of the toothed sectors 370 can be unequally spaced apart by one or more non-meshing sectors have a different length. This alternative embodiment provides thus one or more relative enlarged and/or reduced contacting zone(s) between the pair of mutually intermeshing components notably for locally modifying the joint rigidity and/or load charge capacity of the joint.

The relative rotation between the first component 310 and the second component 360 of the partial Hirth can be driven—preferably—by an automatic actuator such as an electric motor, or by a manual mechanism. In both cases, the joint may comprise an angle encoder configured to measure the relative angular position during the reorientation (unlocked Hirth) and/or when repositioned (locked Hirth). In case of a motorized articulated wrist, the wrist or the machine controller 25 of the CMM 40 can be configured to read the relative angular position provided by such encoder for driving the reorientation though the actuator and/or for confirming a correct locking at a desired indexed angular position.

In a possible variant of the invention, the encoder is a six degrees-of-freedom sensor (6dof) providing a position and an orientation of the second component 360 relative to the first one 310. This information may be used for collision detection, correction of measurement error when the Hirt is locked or in any other useful way. The machine controller 25 of the CMM 40 may be configured to regularly read the sensor (e.g. each millisecond) when the Hirth is locked. Fast scanning times are especially useful when the encoder is used to detect collisions.

The 6dof sensor may include a reader affixed to the first component 310 and a scale affixed to the second one 360, or the other way around.

The indexed articulated joint can comprise an axially extending peripheral protection for protecting the modified Hirth coupling against dust and/or fluid penetration (not illustrated). The protection can comprise a cylindrical flange being peripherally fixed to one of the first and second component 310, 360 while extending towards the other one to envelop its peripheral side both in locked and unlocked configuration. Complementarily, the other component can comprise an additional peripheric flange or joint configured to cooperate with such flange for increasing tightness. Alternatively, the extending peripheral protection can comprise a bellows being fixed to both the peripheries of the first and second component 310, 360 to provide the required tightness.

The modified Hirth coupling can also be used in a probe holder (not illustrated) to provide a reorientation of a probe 400 around one single axis (e.g. “S”-axis), eventually in addition to the one(s) provided by the wrist (e.g. “C”-axis). In such case, one of the first and second component 310, 360 is fixed to a support element of the rotary adapter of the probe holder, the support element being capable to be mount to the position platform 45 of the CMM 40, alternatively or complementarily to the first or second reorientable element 200,300 of the wrist 10. The other of the first and second component 310, 360 is then fixed to a probe support on which the probe can be mount, or directly to the probe.

The modified Hirth coupling of the invention can also be used in the rotary table so as to provide an indexable reorientation of the workpiece to be measured. One of the first and second component 310, 360 can be thus attached to a support element being configured to fix the rotary table on a reference table 43, or to another surface of the measuring apparatus 40. The other of the first and second component 310, 360 can then be connected to a workpiece support configured to hold the workpiece for measurements.

### REFERENCE SYMBOLS IN THE FIGURES

10 articulated wrist
25 machine controller
30 workpiece
40 coordinate measuring machine, CMM
41 bridge
42 carriage
43 table
45 Z-ram, quill, positioning platform
60 “A” axis (horizontal)
70 “B” axis (vertical)
100 support element
103 connector
200 reorientable element
220 visual indicators
300 additional reorientable element
310 first intermeshing component
321 equally spaced teeth on the first intermeshing component
360 second intermeshing component
370 equally spaced toothed sectors
371 teeth on the second intermeshing component
375 non-meshing sectors
400 stylus, end sensor
415 touch tip

1. An indexed articulated joint for the reorientation of a metrological tool of a measuring apparatus and/or of a workpiece within a measuring volume of a measuring apparatus, the indexed articulated joint comprising:
a support element capable of being mounted on the measuring apparatus or on a component thereof,
a reorientable element rotatably connected to the support element, wherein the reorientable element can be rotated relative to the support element about a first rotation axis between and locked at one of a plurality of indexable orientations separated equally by a pitch angle,
a modified Hirth coupling with two mutually intermeshing components, one in the support element, another in the reorientable element, wherein
a first component of the modified Hirth coupling has a plurality of teeth spaced apart equally by a multiple of the pitch angle, a second component of the modified Hirth coupling has three or more toothed sectors separated by non-meshing sectors, each toothed sector comprising a plurality of teeth spaced apart by the pitch angle wherein, when the first component and the second component are locked together in any of the indexed positions, each one of the toothed sectors intermeshes with at least one tooth of the first component and there is a clearance between the non-toothed sectors and the first component.

2. The indexed articulated joint of claim 1, wherein each toothed sector includes at least K teeth, where K denotes an integer ratio between the angular spacing of adjacent teeth in the first component and the pitch angle.

3. The indexed articulated joint of claim 2, wherein each toothed sector includes K+1 teeth or K+2 teeth.

4. The indexed articulated joint of claim 1, wherein the toothed sectors are equally spaced apart in angle.

5. The indexed articulated joint of claim 1, wherein at least one of the toothed sectors is constituted by a different number of teeth and/or is unequally spaced apart in angle.

6. The indexed articulated joint of claim 2, wherein the second component has exactly three, four, or six toothed sectors and the ratio K is exactly four, six or eight.

7. The indexed articulated joint of claim 1, wherein the pitch angle is 5°, 2.5°, 2°, or 1°.

8. The indexed articulated joint of claim 1, wherein the teeth have oblique flanks meeting at an angle that is smaller than or equal to 90°.

9. The indexed articulated joint of claim 1, comprising automatic actuators for driving the rotation of the reorientable element about the first rotation axis and/or for locking the support element and the reorientable element together by urging one against the other.

10. The indexed articulated joint of claim 1, comprising an angle encoder configured to measure a rotation angle of the reorientable element relative to the support element about the first rotation axis.

11. The indexed articulated joint of claim 1, comprising an axially extending peripheral protection fixed to the first and/or the second component for protecting the modified Hirth coupling against dust and/or fluid penetration, notably being a bellows.

12. An articulated wrist or a probe holder for a reorientation of a metrological tool mounted on a positioning platform of a measuring apparatus, the articulated wrist or the probe holder comprising the indexed articulated joint of claim 1, wherein the support element is capable of being mounted on the positioning platform.

13. The articulated wrist of claim 12, presenting an additional reorientable element rotatably connected to the reorientable element such that an orientation of the additional reorientable element relative to the reorientable element can be changed between, and locked at one of, a plurality of indexable orientations about a second rotation axis orthogonal to the first rotation axis, the tool being affixed to the additional reorientable element.

14. A rotary table for the reorientation of a workpiece within a measuring volume of a measuring apparatus, the rotary table comprising the indexed articulated joint of claim 1, wherein the support element s capable of being mounted on a reference table or surface of the measuring apparatus.

15. Use of the articulated wrist of claim 12 in a coordinate measuring machine to reorient a coordinate probe.
